(19) United States
(12) Patent Application Publication
(10) Pub. No.: US 2001/0048970 A1
(43) Pub. Date: Dec. 6, 2001

(54) Process for producing coated catalysts by CVD

(76) Inventors: Alfred Hagemeyer, Rheine (DE); Harald Werner, Bad Homburg (DE); Uwe Dingerdissen, Seeheim-Jugenheim (DE); Klaus Kuhlein, Kelkheim (DE); Andre Manz, Sinzheim (DE); Roland Fischer, Bochum (DE)

Correspondence Address: Ashley I. Pezzner, Esquire, CONNOLLY BOVE LODGE & HUTZ LLP, 1220 Market Street, P.O. Box 2207, Wilmington, DE, 19899, US

(21) Appl. No.: 09/739,061

(22) Filed: Dec. 18, 2000

(30) Foreign Application Priority Data
Jun. 23, 1998 (DE) 198 27 844.6
Jun. 11, 1999 (EP) PCT/EP99/04031

(51) Int. Cl. B05D 7/00

(52) U.S. Cl. 427/217

(57) ABSTRACT

The invention relates to a method of producing Pd/Au-containing supported catalysts by CVD (chemical vapor deposition) of vaporizable Pd/Au precursors. For this purpose, suitable noble metal precursors are vaporized and deposited on porous support bodies and subsequently reduced thermally or chemically to the metal and thereby fixed to the support. In particular, the invention relates to the production of Pd/Au coated catalysts on porous supports by this method.

The supported catalysts produced in this way can be used for many heterogeneously catalyzed reactions such as hydrogenations and oxidations.

Pd/Au coated catalysts produced by this method can, according to the invention, be used in the synthesis of vinyl acetate.

### DESCRIPTION

The invention relates to a process for producing Pd/Au-containing supported catalysts by CVD (chemical vapor deposition) of vaporizable Pd/Au precursors. The supported catalysts produced in this way can be used for many heterogeneously catalyzed reactions such as hydrogenations and oxidations, in particular for the synthesis of vinyl acetate.

It is known that vinyl acetate (VAM=vinyl acetate monomer) can be prepared in the gas phase from ethylene, acetic acid and oxygen; the supported catalysts used for this synthesis comprise Pd and an alkali metal, preferably K. Further additives used are Cd, Au or Ba. The metal salts can be applied to the support by impregnation, spraying on, vapor deposition, dipping or precipitation.

Thus, for example, U.S. Pat. No. 3,743,607 describes the production of supported Pd/Au catalysts for the synthesis of VAM by impregnation with Pd/Au salts and subsequent reduction. However, this does not give coated catalysts, but instead the noble metals are uniformly distributed over the entire cross section of the pellet.

GB 1 283 737 discloses the production of a noble metal coated catalyst by preimpregnation of the support with an alkaline solution and saturation with 25-90% of water or alcohol. Subsequent impregnation with Pd salts and reduction of the deposited salts to the metal gives coated catalysts in which the penetration depth of the noble metals is set to be up to 50% of the pellet radius.

Furthermore, the production of coated catalysts by impregnation of the support with a solution of Pd/Au salts and with an aqueous base, preferably NaOH, resulting in precipitation of insoluble Pd and Au hydroxides in a shell-like surface zone on the pellets, is known (U.S. Pat. No. 3,775,342; U.S. Pat. No. 3,822,308). The hydroxides fixed in the shell in this way are then reduced to the metals.

GB 1 521 652 obtains catalysts of the egg-white type, i.e. only an internal ring of the spherical SiO₂ support comprises the noble metals while the inner core and a thin outer shell remain virtually free of noble metals, by the same procedure (preimpregnation with Pd, Au salts, drying, base precipitation, reduction).

U.S. Pat. No. 4,048,096 precipitates water-insoluble Pd and Au compounds on the support preimpregnated with Pd/Au salts using sodium silicates in place of NaOH. The shell thickness here is less than 0.5 mm. Likewise, U.S. Pat. No. 5,185,308 fixes the noble metals in the shell using sodium metasilicate or NaOH, with, in contrast to U.S. Pat. No. 4,048,096, a higher Au/Pd ratio in the range from 0.6 to 1.25 being selected.

EP 0 519 435 discloses the production of a coated Pd/Au/K or Pd/Cd/K catalyst using a method in which a specific support material is washed with an acid prior to the impregnation and is treated with a base after the impregnation.

U.S. Pat. No. 4,087,622 describes the production of coated catalysts by prenucleation with (reduced) Pd/Au metal nuclei in a low concentration. This prenucleation step is carried out by impregnating the porous SiO₂ or Al₂O₃ support with a Pd/Au salt solution, drying it and then reducing the Pd/Au salt to the metal. The prenucleation step is followed by deposition of the catalytically necessary amount of noble metal, i.e. the main amount, which then accumulates in a shell close to the surface.

The CVD (chemical vapor deposition) process has been known for a long time in the prior art as a coating method. This process is mainly used in the production of functional materials such as optical waveguides, insulators, semiconductors, conductor strips and layers of hard material.

Chemical vapor deposition is among the most important processes in thin film technology. In this process, molecular precursors transported in the gas phase react on hot surfaces in the reactor to form adherent coatings. Gas phase methods derived from metal-organic chemical vapor deposition (MOCVD) are in many respects interesting alternatives for the synthesis of catalysts, since interfering salts and stabilizers are not present. The internal surfaces of support materials can thus be nucleated with very finely divided, pure metal particles. Infiltration into the pores of a support is known as chemical vapor infiltration (CVI).

Overviews of the principle and applications of the CVD technique may be found, for example, in the following references: A. Fischer, Chemie in unserer Zeit 1995, 29, No. 3, pp. 141-152; Weber, Spektrum der Wissenschaft, April 1996, 86-90; L. Hitchman, K. F. Jensen, Acad. Press, New York, 1993 and M. J. Hampden-smith, T. T. Kodas, The Chemistry of Metal CVD, VCH, Weinheim, 1994.

It is an object of the present invention to provide a coating method for producing coated catalysts which avoids the disadvantages of the conventional impregnation technique and, in particular, allows the inexpensive, rapid and reproducible production of supported catalysts having a well-defined and controllable shell structure (of the eggshell or egg-white type).

Here, eggshell refers to an outer shell which extends inward from the outer surface.

On the other hand, egg-white refers to an “internal annular shell” in a zone close to the surface of the shaped body somewhat below the outer surface, where the zone right on the outside and not containing noble metals is supposed to keep catalyst poisons away from the catalytically active layers underneath and thus protect the active layers from poisoning.

The type of shell and the shell thickness (penetration depth of the noble metal precursors) can be influenced experimentally, e.g. via the pressure.

It has now been found that the use of the CVD process in combination with suitable precursors and control of the process parameters makes it possible to produce supported Pd/Au catalysts which have significantly improved metal dispersion, uniformity and significantly reduced particle sizes together with greater active metal surface areas and thus increased activity compared to catalysts produced by the impregnation technique.

The coated catalysts described in the prior art are produced by impregnation, steeping, dipping or spray impregnation. CVD has not been employed hitherto.

The process of the invention makes it possible to produce noble metal coated catalysts having a defined shell thickness on porous ceramic supports by coating the support material with noble metal precursors which can be vaporized without decomposition by the chemical vapor deposition (CVD) process, with the noble metals being fixed by simultaneous or subsequent thermal or chemical reduction.

Compounds suitable as (noble metal) precursors, i.e. active metal compounds which can be concentrated in the shell, are all compounds of usable metals which can be vaporized without decomposition, including their mixtures.

Preference is given to Pd, Au, Pt, Ag, Rh, Ru, Cu, Ir, Ni and/or Co. Particular preference is given to Pd, Pt, Ag, Rh and Au, in particular Pd and Au.

Suitable Pd precursors are, for example, Pd(allyl)_{2,} Pd(C₄H₇)acac, Pd(CH₃allyl)_{2,} Pd(hfac)₂, Pd(hfac)(C₃H₅), Pd(C₄H₇)(hfac) and PdCp(allyl), in particular PdCp(allyl). (acac=acetylacetonate, hfac=hexafluoroacetylacetonate, Cp=cyclopentadienyl, tfac=trifluoroacetylacetonate, Me=methyl).

Suitable Au precursors are, for example, Me₂Au(hfac), Me₂Au(ffac), Me₂Au(acac), Me₃Au(PMe₃), CF₃Au(PMe₃), (CF₃)₃Au(PMe₃), MeAuP(OMe)₂Bu^{t}, MeAuP(OMe)₂Me and MeAu(PMe₃). Preference is given to Me₃PAuMe.

The noble metals are fixed on the support by thermal chemical reduction, subsequent to or simultaneously with the coating step.

The process of the invention makes it possible to produce coated catalysts having a significantly better metal dispersion and uniformity, i.e. an essentially monomodal and narrow-band particle size distribution, and also smaller particle sizes. The mean particle diameter of the nanosize particles is usually in the range from 1 nm to 100 nm.

The shell thickness can be controlled and easily matched to the catalytic requirements by means of the CVD process parameters. The process of the invention allows the residue-free fixing of nanosize particles on the support material when using suitable organometallic precursors.

In the case of Pd/Au/K VAM catalysts, it has been found to be advantageous to apply the two noble metals in the form of a shell on the support, i.e. the noble metals are distributed only in a zone close to the surface while the regions deeper within the shaped support body are virtually free of noble metal. The thickness of these catalytically active shells is about 5 μm-10 mm, in particular from 10 μm to 5 mm, particularly preferably from 20 μm to 3 mm.

The present coated catalysts make it possible to carry out the process more selectively or to expand the capacity compared to a process using catalysts in which the support particles are impregnated into the center (“impregnated-through”).

In the preparation of vinyl acetate, it has, for example, been found to be advantageous to keep the reaction conditions the same as when using impregnated-through catalysts and to produce more vinyl acetate per reactor volume and unit time. This makes the work-up of the resulting crude vinyl acetate easier, since the vinyl acetate content of the reactor outlet gas is higher, which additionally leads to an energy saving in the work-up section.

Suitable work-ups are described, for example, in U.S. Pat. No. 5,066,365, DE-A-34 22 575, DE-A-34 08 239, DE-A-29 45 913, DE-A-26 10 624, U.S. Pat. No. 3,840,590. If, on the other hand, the plant capacity is kept constant, the reaction temperature can be lowered and the reaction can thus be carried out more selectively at the same total output, resulting in a saving of raw materials. Here, the amount of carbon dioxide which is formed as by-product and therefore has to be discharged and the loss of entrained ethylene associated with this discharge are also reduced. Furthermore, this procedure leads to a lengthening of the catalyst operating life.

The reduction of the precursors, thermally and/or chemically (e.g. H₂ gas), during and/or after coating by CVD, leads to detachment of the ligand sphere and the formation of “naked” and therefore highly active metallic nanosize particles (unhindered access of the reactant molecules to the metal surface). Since the ligands are small volatile molecules which can readily be removed by application of a gentle vacuum and/or elevated temperature, “residue-free” nanosize particles can be produced without the otherwise customary contamination by solvents, counterions, etc., which remain irreversibly adsorbed on the metal surface and can thus have a deactivating effect.

In a variant of the invention, the coating with the noble metals and the fixing of them to the support can be carried out simultaneously in one step by, for example, using a reducing agent such as H₂ as carrier gas and/or maintaining the support at an elevated temperature, so that the noble metal precursors are reduced immediately after they have been deposited on the support surface and are fixed in this way.

Coating of the support material by means of the CVD process is usually carried out in a pressure range of 10⁻⁴-760 torr and at an oven temperature in the range of 20-600° C. and a reservoir temperature of 20-100° C. For CpPd(allyl), for example, the following parameters are preferred:

| Pressure | 2 × 10⁻² torr |
|---|---|
| Reservoir temperature | 27° C. = RT |
| Oven temperature | 330° C. for 1 h |
| Amount of precursor | 300 mg of CpPd(allyl) |

As supports, it is possible to use inert materials such as SiO₂, Al₂O₃, TiO_{2,} ZrO₂, MgO, their mixed oxides or mixtures of these oxides, SiC, Si₃N₄, C, in the form of spheres, pellets, rings, stars or other shaped bodies. The diameter or the length and thickness of the support particles is generally from 3 to 9 mm. The surface area of the supports, measured by the BET method, is generally 10-500 m²/g, preferably 20-250 m²/g. The pore volume is generally from 0.3 to 1.2 ml/g.

Particularly useful catalysts for the synthesis of vinyl acetate have been found to be coated Pd/Au catalysts which are additionally promoted with alkali metal acetates, preferably potassium acetate. The potassium promoter and further promoters and activators can be applied to the support before and/or after coating with Pd/Au precursors by CVD. As further promoters or activators, it is possible to use, for example, compounds of Cd, Ba, Sr, Cu, Fe, Co, Ni, Zr, Ti, Mn, La or Ce. Normally, according to the method of the invention, the support is firstly coated with Pd and, if desired, Au precursors in a zone close to the surface (shell) by means of CVD, the noble metal precursors are reduced to the metals and the support is then, if desired, impregnated with alkali metal acetates or alkaline earth metal acetates, in particular sodium, potassium, cesium or barium acetate, so that the alkali or alkaline earth metal is uniformly distributed over the pellet cross section.

The metal contents of the finished vinyl acetate monomer (VAM) catalysts are as follows:

The Pd content of the Pd/Au/K catalysts is generally from 0.5 to 2.0% by weight, preferably from 0.6 to 1.5% by weight. The K content is generally from 0.5 to 4.0% by weight, preferably from 1.5 to 3.0% by weight. The Au content of the Pd/K/Au catalysts is generally from 0.2 to 1.0% by weight, preferably from 0.3 to 0.8% by weight.

At least one precursor of each of the elements to be applied to the support particles (Pd/Au/K) has to be applied. It is possible to apply a plurality of precursors of each element, but it is usual to apply exactly one salt of each of the three elements. The necessary loadings can be applied in one step or by multiple deposition.

If a plurality of noble metals are to be fixed to the support (e.g. Pd and Au), alloys or structured nanostructures, i.e. gold on palladium or palladium on gold, can be produced by the method of the invention. The Pd and Au precursors can be applied simultaneously or in succession. Furthermore, the CVD technique can also be combined with the classical impregnation technique by, for example, vapor-depositing only Pd and impregnating the support with Au salts during, before and/or after coating with Pd.

The CVD process parameters, for example type and partial pressure of the carrier gas, partial pressure of the precursors, introduction of further inert or diluent gases, contact time, temperature, etc., allow simple monitoring and control of the shell thickness which can thus be optimally matched to requirements. Thus, for example, it is readily possible to set shell thicknesses in the range from 5 μm to 10 mm, in particular from 10 μm to 5 mm. In particular, it is possible to achieve lower shell thicknesses than can be obtained by the impregnation technique whose lower limit is about 0.5 mm. The coating process can be controlled so that shell structures of the eggshell or egg-white type can be produced.

Furthermore, higher noble metal loadings on the support are possible (owing to the good dispersion of the metal), working steps are saved and the energy-intensive treatment with highly dilute solutions is avoided. Solubility problems play no role since the CVD process employs no solvents. Instead, an inert or reactive carrier gas is usually used for transporting the precursors into the coating chamber. If the precursors have a sufficient vapor pressure or if sufficient vacuum is applied, the carrier gas can also be dispensed with and the partial pressure of the precursors can be regulated by means of the vaporization temperature in the reservoir.

The meticulously clean apparatuses and solvents (twice-distilled water) often required for preparing the impregnation solutions are completely dispensed with in the CVD technique. Impurities in solvents often lead to undesirable agglomeration of particles and can even act as catalyst poisons.

The supported catalysts produced in this way can be used for many heterogeneously catalyzed reactions such as hydrogenations and oxidations.

Coated Pd/Au catalysts produced by this method can, according to the invention, be used in the synthesis of vinyl acetate.

The process of the invention thus makes it possible to produce an activate and selective coated VAM catalyst based on Pd/Au quickly and inexpensively using few process steps while at the same time allowing the shell thickness to be readily controlled.

Compared to the process employed in industry, namely precipitation of noble metal hydroxides using NaOH followed by a reduction step, the invention has the additional advantage of a tremendous time saving (and thus cost saving) in the production of the catalyst. This is because, according to the invention, the shell can be produced in a few minutes while the precipitation using NaOH extends over more than 20 hours. The subsequent reduction step which is additionally required in the conventional procedure can be dispensed with in the process of the invention, since the formation of the shell structure and the reduction to the metals can be carried out simultaneously in one step.

Vinyl acetate is generally prepared by passing acetic acid, ethylene and oxygen or oxygen-containing gases at temperatures of from 100 to 220° C. preferably from 120 to 200° C., and pressures of from 1 to 25 bar, preferably from 1 to 20 bar, over the finished catalyst, with unreacted components being able to be circulated. The oxygen concentration is advantageously kept below 10% by volume (based on the gas mixture without acetic acid). Dilution with inert gases such as nitrogen or carbon dioxide is also advantageous under some circumstances. Carbon dioxide is particularly suitable for dilution since it is formed in small amounts during the reaction.

Selectivities of 90% and more are achieved by the process of the invention.

Owing to their significantly improved metal dispersion and uniformity and significantly reduced particle sizes with larger active metal surface areas, the coated catalysts of the invention have high activities and selectivities.

The following examples illustrate the invention.

### EXAMPLES

### EXAMPLE 1

Synthesis of the Pd precursor: (η3-Allyl)(η5-cyclpopentadienyl)palladium(II)

2Na₂PdCI₄+2CH₂=CHCH₂CI+2CO+2H₂O→(η3-C₃H₅)₂Pd₂Cl₂+4NaCI+2CO₂+4HCI

In a three-necked flask fitted with reflux condenser, dropping funnel, gas inlet and pressure relief valve, palladium chloride (8.88 g, 50 mmol) and sodium chloride (5.90 g, 50 mmol) were dissolved in methanol (120 ml) and water (20 ml). While stirring, allyl chloride (13.5 ml, 134 mmol) was added dropwise to the solution and CO (2-2.5 I/h) was subsequently bubbled through the reddish brown solution. The yellow suspension was poured into water (300 ml), extracted twice with chloroform (100 ml), the chloroform phase was washed twice with distilled water (2×150 ml) and the extract was dried over calcium chloride. The extract was filtered and dried under reduced pressure.

Result: yellow powder

Yield: 6.67 g, 18.2 mmol

The product was processed further without characterization.

(η3-C₃H₅)₂OdCU₂+2NaC₅H₅→2Pd(η3-C₃H₃)(η5-C₅H₅)+2NaCI

Note: (η3-allyl)(η5-cyclopentadienyl)palladium is volatile and has an unpleasant odor.

Allylpalladium chloride (6.67 g, 18.2 mmol) in toluene (50 ml) and tetrahydrofuran (50 ml) was placed under nitrogen in a two-necked flask fitted with Schlenk facilities, pressure relief valve and dropping funnel. The mixture was cooled to −20° C. by means of a salt/ice mixture, sodium cyclopentadienide (3.2 g, 36.3 mmol) in THF was slowly added dropwise and the mixture was stirred at −20° C. for one hour. The color changed from yellow to dark red. After warming to room temperature, the mixture was stirred for a further hour to complete the reaction. Slow removal of the solvent under reduced pressure gave a red solid which was extracted with pentane. Removal of the solvent from the filtered extract under reduced pressure (30-60 torr) gave red needles.

Yield: 4.92 g, 23.3 mmol (64%)

### EXAMPLE 2

Synthesis of the Au precursor

Trimethylphosphinemethylgold

(CH₃)₃PAuCI+CH₃Li→(CH₃)₃PAuCH₃

A solution of methyllithium is added while stirring at −10° C. to a suspension of trimethylphosphinegold(l) chloride (1.0 g, 3.24 mmol) in ether (20 ml) and the mixture is stirred further at −10° C. for half an hour and at room temperature for two hours.

Subsequently, water (15 ml) is added dropwise while cooling in an ice bath, resulting in the color changing from milky white to black. The mixture is shaken with ether, the ether layer is separated off and dried over sodium sulfate. Evaporation and sublimation gave white trimethylphosphinemethylgold.

Yield: 422 mg, 1.46 mmol (45% of the theoretical yield)

### EXAMPLE 3

CVD of the precursors onto porous Siliperl SiO₂ support spheres

| | Palladium precursor | Gold precursor |
|---|---|---|
| Pressure | 40 torr | 10⁻³ torr |
| Reservoir | 180° C. = RT | 50° C. |
| temperature | | |
| Oven temperature | 300° C. | 300° C. |
| Amount of precursor | 750 mg | 85 mg |
| Carrier gas | Nitrogen | None |
| deposition time | 45 min./2.5 h | 3 h |

The support was nucleated with a small amount of Pd precursor, the Au precursor was subsequently vapor-deposited and the remaining Pd precursor was then again vapor-deposited. The carrier gas flow was 10.7 cm³/min. The sample was analyzed by means of TEM-EDX and SEM-EDX.

The shell thickness is about 50 μm. The particle size determined by TEM is 2-5 nm. Elemental chemical analysis indicated a noble metal loading of 0.52% of Pd and 0.28% of Au.

### EXAMPLE 4

Conversion into the Industrial VAM Catalyst

The Pd/Au-laden Siliperl SiO₂ support spheres from Example 3 are subsequently impregnated with potassium acetate.

For this purpose, 2 g of KOAc are dissolved in water and added together to 50 ml of spheres. The solution is allowed to soak in well while rotating the mixture. The catalyst is dried at 110° C. in a drying oven.

Reactor tests:

The catalysts produced in the examples are tested in a tubular fixed-bed microreactor having a capacity of 36 ml. The gases are metered in via mass flow controllers and the acetic acid is metered in using a liquid flow controller (from Bronkhorst). The gases and the acetic acid are mixed in a packed gas mixing tube. The output from the reactor is depressurized to atmospheric pressure and passed through a glass condenser. The condensate collected is analyzed off-line by means of GC. The noncondensable gases are determined quantitatively by on-line GC.

Before the measurement, the catalyst is activated in the reactor as follows: The catalyst is heated from about 25° C. to 155° C. under N₂ at atmospheric pressure.

At the same time, the gas temperature is increased to 150° C. and the gas mixing temperature is increased to 160° C. The conditions are maintained for some time.

Ethylene is subsequently fed in and the pressure is increased to 10 bar. After a hold time, acetic acid is metered in and the conditions are maintained for some time.

After the activation, the catalyst is run up and measured as follows: Oxygen is added downstream of the gas mixing tube and the oxygen concentration is increased stepwise to 4.8% by volume (1st measurement) and later to 5.2% by volume (2nd measurement). Care always has to be taken to ensure that the explosion limits of the ignitable ethylene/O₂ mixture are not exceeded. At the same time, the reactor temperature is increased to 170° C.

The reaction is continually monitored using the gas chromatograph. When the reaction has reached a steady state, i.e. the reactor temperature is constant and the concentrations of vinyl acetate and CO₂ in the product gas stream are constant, sampling is commenced.

A liquid sample and a number of gas samples are taken over a period of about 1 hour.

The product gas flow is determined by means of a gas meter. After testing is complete, the oxygen concentration is firstly reduced stepwise.

The results obtained from the reactor are shown in Table 1.

| | | O₂ feed | Coating | Selectivity | STY |
|---|---|---|---|---|---|
| Example | Cat. No | Conc. [%] | Method | [%] | [g/l×h] |
| 1 | HAM00002 | 4.8 | CVD | 93.5 | 380 |

claims:

1. A process for producing noble metal coated catalysts having a defined shell thickness on porous ceramic supports by coating the support material with precursors which can be vaporized without decomposition by the chemical vapor deposition (CVD) process and fixing the metals by simultaneous or subsequent thermal or chemical reduction.

2. The process as claimed in claim 1, wherein the precursors used are organometallic compounds of Pd, Au, Pt, Ag, Rh, Ru, Cu, Ir, Ni and/or Co.

3. The process as claimed in claim 1 or 2, wherein coating with the noble metals and fixing of the noble metals are carried out simultaneously in one step.

4. The process as claimed in any one of claims 1 to 3, wherein coating by the CVD process is carried out at a pressure in the range from of 10⁻⁴ to 760 torr and at an oven temperature in the range from 20 to 600° C.

5. The process as claimed in any one of claims 1 to 4, wherein the support materials used are SiO₂, Al₂O₃, TiO₂, ZrO₂, MgO, their mixed oxides or mixtures of these oxides, SiC, Si₃N₄, C.

6. The process as claimed in any one of claims 1 to 5, wherein the support material has a surface area of from 10 to 500 m²/g.

7. The process as claimed in any one of claims 1 to 6, wherein the precursors used are one or more of the following compounds:
Pd(allyl)_{2,} Pd(C₄H₇)acac, Pd(CH₃allyl)₂, Pd(hfac)₂, Pd(hfac)(C₃H₅), Pd(C₄H₇)(hfac), PdCp(allyl), Me₂Au(hfac), Me₂Au(tfac), Me₂Au(acac), Me₃Au(PMe₃), CF₃Au(PMe₃), (CF₃)₃Au(PMe₃), MeAuP(OMe)₂Bu^{t}, MeAuP(OMe)₂Me and/or MeAu(PMe₃).

8. The process as claimed in any of claims 1 to 7, wherein further promoters and/or activators are applied to the support together with the precursors by means of the CVD process.

9. The process as claimed in claim 8, wherein the further promoters or activators used are Cd, Ba, Sr, Cu, Fe, Co, Ni, Zr, Ti, Mn, La or Ce compounds.

10. The process as claimed in any of claims 1 to 9, wherein the coated catalyst is subsequently impregnated with potassium acetate, sodium acetate, cesium acetate or barium acetate or a mixture thereof by wet chemical means in a final step.

11. A coated catalyst having a defined shell thickness and obtainable by a process as claimed in any one of claims 1 to 10.

12. A coated catalyst as claimed in claim 11 having a shell thickness in the range from 10 μm to 5 mm.

13. A coated catalyst as claimed in claim 11 or 12, wherein the noble metals are concentrated in the pores of the support material in a shell-like zone close to the surface of the eggshell or egg-white type.

14. The use of a coated catalyst as claimed in any one of claims 11 to 13 in the preparation of vinyl acetate in the gas phase.
